(19) United States
(12) Patent Application Publication
(10) Pub. No.: US 2013/0133461 A1
(43) Pub. Date: May 30, 2013

(54) ENERGY ABSORBING STEERING COLUMN ASSEMBLY

(71) Applicants: Melvin L. Tinnin, Clio, MI (US); Steven P. Finkbeiner, Bay City, MI (US); Michael P. Anspaugh, Bay City, MI (US)

(72) Inventors: Melvin L. Tinnin, Clio, MI (US); Steven P. Finkbeiner, Bay City, MI (US); Michael P. Anspaugh, Bay City, MI (US)

(73) Assignee: NEXTEER (BEIJING) TECHNOLOGY CO., LTD., Saginaw, MI (US)

(21) Appl. No.: 13/307,522

(22) Filed: Nov. 30, 2011

(51) Int. Cl. B62D 1/19

(52) U.S. Cl. 74/493

(57) ABSTRACT

A steering column assembly includes an inner jacket disposed along a longitudinal axis and coupled to a host structure of a vehicle. The steering column assembly also includes an outer jacket arranged co-axially about the inner jacket and the longitudinal axis. The outer jacket is configured to translate along the longitudinal axis relatively to the inner jacket to thereby facilitate telescoping motion of the steering column assembly. The outer surface of the inner jacket and the inner surface of the outer jacket cooperate to define a telescope-inhibiting range of motion of the steering column assembly along the longitudinal axis. The steering column assembly is configured to impose telescope-resisting forces as the length of the steering column assembly decreases within the telescope-inhibiting range of motion.

### BACKGROUND OF THE INVENTION

The present invention relates generally to energy absorbing steering column assemblies and more particularly to an energy absorbing steering column assembly that includes coaxial tubes having a friction-modified surface disposed so as to resist relative movement of the tubes in the event of an impact between an operator and the steering column assembly.

In today's world, vehicles commonly include a steering column assembly positioned in front of a vehicle operator. In some situations, the operator and others in the vehicle (i.e., occupants) may contact the steering column assembly, whereby kinetic energy of the occupants may be dissipated through compression of the steering column assembly.

Accordingly, it is desirable to have systems and methods for dissipating kinetic energy of vehicle occupants in the event of contact between a vehicle occupant and a steering column assembly.

### SUMMARY OF THE INVENTION

A steering column assembly includes an inner jacket disposed along a longitudinal axis and coupled to a host structure of a vehicle. The steering column assembly also includes an outer jacket arranged co-axially about the inner jacket and the longitudinal axis. The outer jacket is configured to translate along the longitudinal axis relatively to the inner jacket to thereby facilitate telescoping motion of the steering column assembly. The outer surface of the inner jacket and the inner surface of the outer jacket cooperate to define a telescope-inhibiting range of motion of the steering column assembly along the longitudinal axis. The steering column assembly is configured to impose telescope-resisting forces as the length of the steering column assembly decreases within the telescope-inhibiting range of motion.

A steering column assembly includes an outer jacket disposed along a longitudinal axis and coupled to a host structure of a vehicle. The steering column assembly also includes an inner jacket disposed about the longitudinal axis within the outer jacket. The inner jacket is configured to translate along the longitudinal axis relatively to the outer jacket to thereby facilitate telescoping motion of the steering column assembly. The outer surface of the inner jacket and the inner surface of the outer jacket cooperate to define a telescope-inhibiting range of motion of the steering column assembly along the longitudinal axis. The steering column assembly is configured to impose telescope-resisting forces as the length of the steering column assembly decreases within the telescope-inhibiting range of motion.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a perspective view of an exemplary steering column assembly configured for dissipating kinetic energy of vehicle occupants in the event of a vehicle collision;

FIG. 2 shows a perspective view of an exemplary steering column assembly configured for dissipating kinetic energy of vehicle occupants in the event of a vehicle collision;

FIG. 3 shows a perspective view of an exemplary steering column assembly configured for dissipating kinetic energy of vehicle occupants in the event of a vehicle collision;

FIG. 4 shows a perspective view of an exemplary steering column assembly configured for dissipating kinetic energy of vehicle occupants in the event of a vehicle collision; and

FIG. 5 shows a perspective view of an exemplary steering column assembly configured for dissipating kinetic energy of vehicle occupants in the event of a vehicle collision.

### DETAILED DESCRIPTION

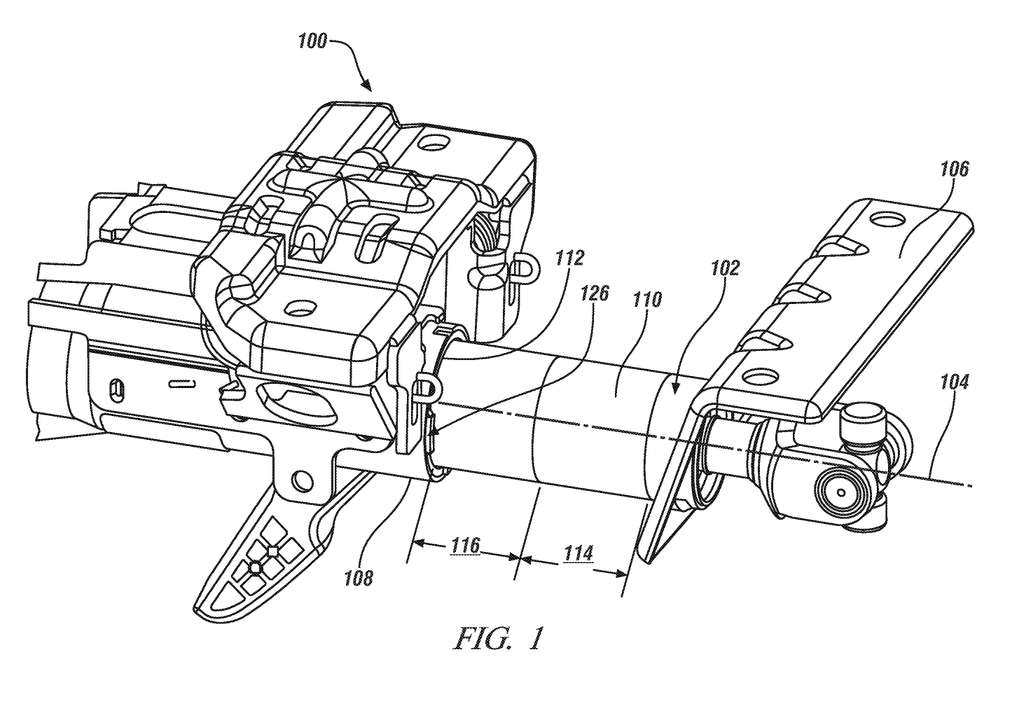

Referring now to the Figures, where the invention will be described with reference to specific embodiments, without limiting same, FIG. 1 shows an exemplary a steering column assembly 100 that includes an inner jacket 102 disposed along a longitudinal axis 104 and coupled to a host structure 106 of a vehicle. An outer jacket 108 is arranged co-axially about the inner jacket 102 and the longitudinal axis 104 and is configured to translate along the longitudinal axis 104 relatively to the inner jacket 102, thereby facilitating telescoping motion of the steering column assembly 100.

An outer surface 110 of the inner jacket 102 and an inner surface 112 of the outer jacket 108 cooperate to define a telescope-inhibiting range of motion 114 of the steering column assembly 100 along the longitudinal axis 104. It should be appreciated that the steering column assembly 100 has a minimum operational length. When the steering column assembly 100 is deployed at lengths less than the minimum operational length, the steering column assembly 100 operates within the telescope-inhibiting range of motion 114, and when the steering column assembly 100 is deployed at lengths greater than the minimum operational length, the steering column assembly 100 operates outside the telescope-inhibiting range of motion 114. Put another way, the telescope-inhibiting range of motion 114 is characterized by steering column lengths that are less than the minimum operational length. In the event of a collision involving an impact with the steering column assembly 100, such that the length of the steering column assembly 100 decreases (i.e., undergoes telescoping compression) such that the length of the steering column assembly 100 is less than the minimum operational length, the steering column assembly 100 travels through the telescope-inhibiting range of motion 114.

In an exemplary embodiment, the outer surface 110 of the inner jacket 102 and the inner surface 112 of the outer jacket 108 cooperate to also define a telescope-facilitating range of motion 116 of the steering column assembly 100 along the longitudinal axis 104. It should be appreciated that the steering column assembly 100 has a maximum operational length. When the steering column assembly 100 is deployed at lengths that are less than or equal to the maximum operational length or that are greater than or equal to the minimum operational length, the steering column assembly 100 operates within the telescope-facilitating range of motion 116. Put another way, the telescope-facilitating range of motion 116 is characterized by steering column lengths that are between the minimum operational length and the maximum operational length. As a vehicle operator adjusts the length of the steering column assembly 100 (i.e., along the longitudinal axis 104) between the minimum operational length and the maximum operational length, the steering column assembly 100 travels through the telescope-facilitating range of motion 116.

In an exemplary embodiment, a bushing 126 is disposed between an outer surface 110 of the inner jacket 102 and an inner surface 112 of the outer jacket 108. The bushing is configured and arranged so as to facilitate telescoping motion of the outer jacket 108 by improving alignment between the outer jacket 108 and the inner jacket 102 and reducing friction between the outer jacket 108 and the inner jacket 102 as they undergo telescoping motion throughout a range of motion, such as the telescope-facilitating range of motion 116. Accordingly, the telescope-facilitating range of motion 116 is characterized by relatively low levels of forces resisting telescoping motion of the steering column assembly 100. For example, forces resisting telescoping motion of the steering column assembly 100 within the telescope-facilitating range of motion 116 are typically in a range facilitating manual adjustment of the position of the steering column assembly.

In an exemplary embodiment, the steering column assembly 100 is configured to impose telescope-resisting forces as the length of the steering column assembly 100 decreases within the telescope-inhibiting range of motion 114. The imposition of the telescope-resisting forces requires input of energy in order to move (e.g., to compress) the steering column assembly 100 within the telescope-inhibiting range of motion 114. Thus, in the event of a collision wherein the steering column assembly 100 is impacted by a vehicle occupant, the steering column assembly 100 may be enabled to absorb (i.e., dissipate) energy of the occupant as the occupant decelerates relatively to the vehicle structure 106 to which the steering column assembly 100 is fixed. Accordingly, the telescope-inhibiting range of motion 114 is characterized by relatively greater levels of forces resisting telescoping motion of the steering column assembly 100. For example, forces resisting telescoping motion of the steering column assembly 100 within the telescope-inhibiting range of motion 114 may be greater than forces typically set to facilitate manual adjustment of the steering column assembly. As those skilled in the art will appreciate the level of forces for resisting telescoping motion may be set so as to accomplish a desirable level of energy dissipation in the event of an impact between the steering column assembly and a vehicle occupant while maintaining acceptable levels of force exerted between the steering column assembly and a vehicle occupant.

In one exemplary embodiment, the telescope-inhibiting forces are relatively constant as the length of the steering column assembly 100 decreases within the telescope-inhibiting range of motion 114. In another exemplary embodiment, the telescope-resisting forces increase as the length of the steering column assembly 100 decreases within the telescope-inhibiting range of motion 114.

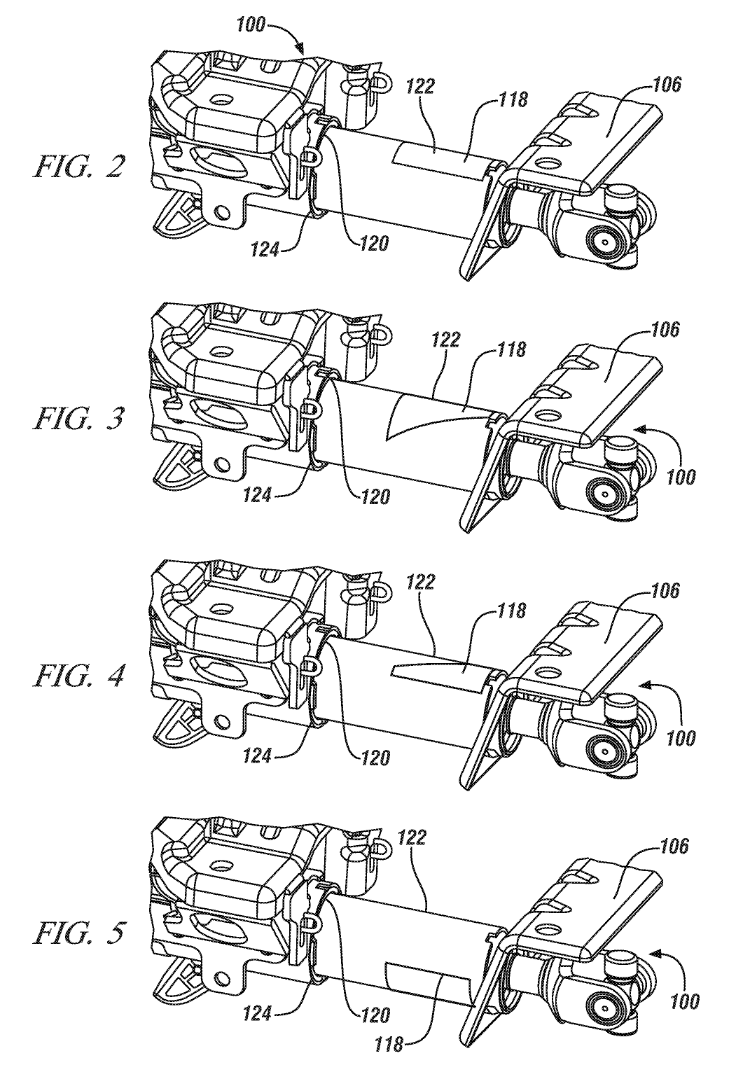

In an exemplary embodiment, the steering column assembly 100 is configured to impose telescope-resisting forces through friction between the inner jacket 102 and the outer jacket 108 as the steering column assembly 100 moves within the telescope-inhibiting range of motion 114. To impose the telescope-resisting forces through friction, one or more of the outer surface 110 of the inner jacket 102 and the inner surface 112 of the outer jacket 108 defines a friction modified region 118 #. As shown in FIGS. 2-5, a friction modified region 118 is applied to the outer surface 110 of the inner jacket 102 and positioned so as to cooperate with a cooperating region 120 defined on the inner surface 112 of the outer jacket 108. As the length of the steering column assembly 100 changes within the telescope-inhibiting range of motion 114, the cooperating region 120 cooperate with the friction modified region 118 so as to impose a telescope-resisting force on the outer jacket 108 and thus to require an input of energy in order to change the length of the steering column assembly 100. It should be noted that a friction modified region 118 may be applied to the inner surface 112 of the outer jacket 108, and a cooperating region 120 may be applied to the outer surface 110 of the inner jacket 102. It should also be noted that, in an exemplary embodiment, the orientation of the inner jacket 102 and the outer jacket 108 may be reversed such that it is the outer jacket 108 that is fixed to the vehicle structure 106 and the inner jacket 102 that moves relatively to the vehicle structure 106 as the steering column assembly 100 undergoes telescoping motion.

In an exemplary embodiment, a friction modified region 118 defines a series of circumferential widths that increase with decreasing length of the steering column assembly 100 such that the telescope-resisting force caused by cooperation of the friction modified region 118 and the cooperating region 120 increases with decreasing length of the steering column. This feature enables the steering column assembly 100 to absorb increasing amounts of impact energy as the steering column assembly 100 undergoes increased deformation toward shorter and shorter lengths. This feature may be useful, for example, for providing increased safety in more severe impact conditions while facilitating more gentle energy absorption under less severe impact conditions. It should be appreciated that by modulating the circumferential width along the longitudinal direction, the telescope-resisting force caused by cooperation of the friction modified region 118 and the cooperating region 120 can be configured so as to meet a desired profile as the length of the steering column assembly 100 decreases (i.e., as the steering column assembly 100 undergoes telescoping motion toward shorter and shorter lengths). For example, the friction modified region 118 and the cooperating region 120 can be configured so that as the length of the steering column assembly 100 decreases, the telescope-resisting force increases. Alternatively, the friction modified region 118 and the cooperating region 120 can be configured such that as the length of the steering column assembly 100 decreases, the telescope-resisting force also decreases.

In an exemplary embodiment, the steering column assembly 100 is configured to impose telescope-resisting forces through deformation of the inner jacket 102 and/or the outer jacket 108 and/or material adhered to the inner jacket 102 and/or the outer jacket 108 as the steering column assembly 100 moves within the telescope-inhibiting range of motion 114. To impose the telescope-resisting forces through deformation, one or more of the outer surface 110 of the inner jacket 102 and the inner surface 112 of the outer jacket 108 defines dimensionally varying region 122. A dimensionally varying region 122 may be characterized by changing cross-sectional shape such as increasing eccentricity or increasing radius. As shown in FIGS. 2-5, a dimensionally varying region 122 is defined by the outer surface 110 of the inner jacket 102 and positioned so as to cooperate with a cooperating region 124 defined on the inner surface 112 of the outer jacket 108. As the length of the steering column assembly 100 changes within the telescope-inhibiting range of motion 114, the cooperating region 124 deforms in response to interference with the dimensionally varying region 122 so as to impose a telescope-resisting force on the outer jacket 108 and thus to require an input of energy in order to change the length of the steering column assembly 100. It should be noted that a dimensionally varying region 122 may be defined by the inner surface 112 of the outer jacket 108, and a cooperating region 124 may be applied to the outer surface 110 of the inner jacket 102.

In an exemplary embodiment, a dimensionally varying region 122 is characterized by a region of steadily increasing cross-sectional areas that increase with decreasing length of the steering column assembly 100 such that the telescope-resisting force caused by cooperation of the dimensionally varying region 122 and the cooperating region 124 increases with decreasing length of the steering column. As with the embodiments described above employing friction, this feature enables the steering column assembly 100 to absorb increasing amounts of impact energy as the steering column assembly 100 undergoes increased deformation toward shorter and shorter lengths. It should be appreciated that by modulating the changes in cross-sectional dimensions along the longitudinal direction, the telescope-resisting force caused by cooperation of the dimensionally varying region 122 and the cooperating region 124 can be configured so as to meet a desired or required load profile as the length of the steering column assembly 100 decreases (i.e., as the steering column assembly 100 undergoes telescoping motion toward shorter and shorter lengths). For example, the dimensionally varying region 122 and the cooperating region 124 can be configured so that as the length of the steering column assembly 100 decreases, the telescope-resisting force increases. Alternatively, the dimensionally varying region 122 and the cooperating region 124 can be configured such that as the length of the steering column assembly 100 decreases, the telescope-resisting force also decreases.

Both the dimensionally varying region 122 and the friction modified region 118 can be created by knurling, sand blasting, etching, machining, or application of a coating such as paint or adhesive tape.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly comprising:
an inner jacket disposed along a longitudinal axis and coupled to a host structure of a vehicle; and
an outer jacket arranged co-axially about the inner jacket and the longitudinal axis;
the outer jacket being configured to translate along the longitudinal axis relatively to the inner jacket to thereby facilitate telescoping motion of the steering column assembly;
wherein the outer surface of the inner jacket and the inner surface of the outer jacket cooperate to define a telescope-inhibiting range of motion of the steering column assembly along the longitudinal axis; and
wherein the steering column assembly is configured to impose telescope-resisting forces as the length of the steering column assembly decreases within the telescope-inhibiting range of motion.

2. The steering column assembly of claim 1, wherein the outer surface of the inner jacket and the inner surface of the outer jacket cooperate to define a telescope-facilitating range of motion of the steering column assembly along the longitudinal axis, the telescope-facilitating range of motion being characterized by relatively low levels of forces resisting telescoping motion of the steering column assembly.

3. The steering column assembly of claim 2, wherein the telescope-facilitating range of motion of the steering column assembly corresponds to a range of lengths that is greater than a range of lengths corresponding to a telescope-inhibiting range of motion of the steering column assembly.

4. The steering column assembly of claim 1, wherein the steering column assembly is configured to impose frictional telescope-resisting forces.

5. The steering column assembly of claim 1, wherein the telescope-resisting forces are relatively constant as the length of the steering column assembly decreases within the telescope-inhibiting range of motion.

6. The steering column assembly of claim 1, wherein the telescope-resisting forces increase as the length of the steering column assembly decreases within the telescope-inhibiting range of motion.

7. The steering column assembly of claim 1, wherein the telescope-resisting forces are relatively constant as the length of the steering column assembly decreases within the telescope-inhibiting range of motion.

8. The steering column assembly of claim 1, wherein the outer surface of the inner jacket defines a friction modified region positioned so as to cooperate with a cooperating region defined on the inner surface of the outer jacket to impose a friction force between the inner jacket and the outer jacket that tends to resist reductions in length of the steering column assembly as the as the steering column assembly moves within the telescope-inhibiting range of motion.

9. The steering column assembly of claim 1, wherein the outer surface of the inner jacket defines a dimensionally varying region positioned so as to cooperate with a cooperating region defined by the inner surface of the outer jacket to impose telescope-resisting forces through deformation of the inner jacket or the outer jacket or material fixed to the inner jacket or the outer jacket, wherein the telescope-resisting forces tend to resist reductions in length of the steering column assembly as the as the steering column assembly moves within the telescope-inhibiting range of motion.

10. The steering column assembly of claim 1, wherein the inner surface of the outer jacket defines a friction modified region positioned so as to cooperate with a cooperating region defined on the outer surface of the inner jacket to impose a friction force between the inner jacket and the outer jacket that tends to resist reductions in length of the steering column assembly as the as the steering column assembly moves within the telescope-inhibiting range of motion.

11. The steering column assembly of claim 1, wherein the inner surface of the outer jacket defines a dimensionally varying region positioned so as to cooperate with a cooperating region defined by the outer surface of the inner jacket to impose telescope-resisting forces through deformation of the inner jacket or the outer jacket or material fixed to the inner jacket or the outer jacket, wherein the telescope-resisting forces tend to resist reductions in length of the steering column assembly as the as the steering column assembly moves within the telescope-inhibiting range of motion.

12. A steering column assembly comprising:
an outer jacket disposed along a longitudinal axis and coupled to a host structure of a vehicle; and
an inner jacket disposed about the longitudinal axis within the outer jacket;
the inner jacket being configured to translate along the longitudinal axis relatively to the outer jacket to thereby facilitate telescoping motion of the steering column assembly;
wherein the outer surface of the inner jacket and the inner surface of the outer jacket cooperate to define a telescope-inhibiting range of motion of the steering column assembly along the longitudinal axis; and
wherein the steering column assembly is configured to impose telescope-resisting forces as the length of the steering column assembly decreases within the telescope-inhibiting range of motion.

13. The steering column assembly of claim 12, wherein the outer surface of the inner jacket and the inner surface of the outer jacket cooperate to define a telescope-facilitating range of motion of the steering column assembly along the longitudinal axis, the telescope-facilitating range of motion being characterized by relatively low levels of forces resisting telescoping motion of the steering column assembly.

14. The steering column assembly of claim 13, wherein the telescope-facilitating range of motion of the steering column assembly corresponds to a range of lengths that is greater than a range of lengths corresponding to a telescope-inhibiting range of motion of the steering column assembly.

15. The steering column assembly of claim 12, wherein the steering column assembly is configured to impose frictional telescope-resisting forces.

16. The steering column assembly of claim 12, wherein the telescope-resisting forces are relatively constant as the length of the steering column assembly decreases within the telescope-inhibiting range of motion.

17. The steering column assembly of claim 12, wherein the telescope-resisting forces increase as the length of the steering column assembly decreases within the telescope-inhibiting range of motion.

18. The steering column assembly of claim 12, wherein the outer surface of the inner jacket defines a friction modified region positioned so as to cooperate with a cooperating region defined on the inner surface of the outer jacket to impose a friction force between the inner jacket and the outer jacket that tends to resist reductions in length of the steering column assembly as the as the steering column assembly moves within the telescope-inhibiting range of motion.

19. The steering column assembly of claim 12, wherein the outer surface of the inner jacket defines a dimensionally varying region positioned so as to cooperate with a cooperating region defined by the inner surface of the outer jacket to impose telescope-resisting forces through deformation of the inner jacket or the outer jacket or material fixed to the inner jacket or the outer jacket, wherein the telescope-resisting forces tend to resist reductions in length of the steering column assembly as the as the steering column assembly moves within the telescope-inhibiting range of motion.

20. The steering column assembly of claim 12, wherein the inner surface of the outer jacket defines a friction modified region positioned so as to cooperate with a cooperating region defined on the outer surface of the inner jacket to impose a friction force between the inner jacket and the outer jacket that tends to resist reductions in length of the steering column assembly as the as the steering column assembly moves within the telescope-inhibiting range of motion.
